(19) United States
(12) Patent Application Publication
(10) Pub. No.: US 2015/0314737 A1
(43) Pub. Date: Nov. 5, 2015

(54) FABRIC COVERED VEHICLE INTERIOR ASSEMBLY HAVING A RECESS

(71) Applicant: MOTUS INTEGRATED TECHNOLOGIES, Holland, MI (US)

(72) Inventors: Michael ZIMMER, Belmont, MI (US); Christopher KRING, Zeeland, MI (US)

(21) Appl. No.: 14/649,986

(22) PCT Filed: Dec. 5, 2013
(86) PCT No.: PCT/US2013/073373

§ 371 Date: Jun. 5, 2015

Related U.S. Application Data
(60) Provisional application No. 61/733,683, filed on Dec. 5, 2012.

(51) Int. Cl. B60R 13/02; B32B 5/02; B32B 3/30; B29C 43/18; B29C 43/20

(52) U.S. Cl. CPC B60R 13/02; B29C 43/18; B29C 43/203; B32B 3/30; B32B 5/02; B29K 2023/12

(57) ABSTRACT

A vehicle interior assembly is provided that includes a fabric having multiple colored portions. The vehicle interior assembly further includes a substrate coupled to the fabric and configured to enhance rigidity to the fabric. Moreover, the substrate includes a recess, and a transition of the fabric between a first colored portion and a second colored portion of the multiple colored portions is disposed within the recess.

### CROSS REFERENCE TO RELATED APPLICATION

This application claims priority from and the benefit of U.S. Provisional Application Ser. No. 61/733,683, entitled “FABRIC COVERED VEHICLE INTERIOR ASSEMBLY HAVING A RECESS”, filed Dec. 5, 2012, which is hereby incorporated by reference in its entirety.

### BACKGROUND

The invention relates generally to a fabric covered vehicle interior assembly, such as a headliner, having a recess.

Certain vehicle interiors include interior assemblies, such as headliners. Some of these interior assemblies are traditionally formed of one colored portion. However, some interior assemblies may include more than one colored portion by using multiple panels each separately constructed using different colors. When the multiple panels are mounted in the vehicle, the resulting interior assembly includes multiple colored portions. However, by creating multiple panels, the manufacture of multi-panel interior assemblies may be more costly than single-panel interior assemblies. For example, multi-panel interior assemblies may require more material, installation, and production time than single-panel interior assemblies. Alternatively, some interior assemblies may dispose multiple colored portions on a single panel, but any imperfections in the design, disposal of the color, and/or placement of the panel may be clearly evident, especially in the transition between two colored portions of the panel. As a result, interior assemblies traditionally include a single colored portion, multiple panels, or a single panel that displays any potential imperfections in the transitions between colored portions in the panel.

### BRIEF DESCRIPTION

In one embodiment, a vehicle interior assembly includes a fabric having multiple colored portions. The vehicle interior assembly also includes a substrate that is coupled to the fabric and configured to enhance rigidity to the fabric. Moreover, the substrate includes a recess has a transition of the fabric between a first colored portion of the plurality of colored portions and a second colored portion of the plurality of colored portions is disposed within the recess.

In another embodiment, a method of manufacturing a vehicle interior assembly includes coupling a fabric having multiple colored portions to a substrate. The method also includes forming a recess in the fabric and the substrate. Moreover, the recess is configured to at least partially conceal a transition between two or more colored portions of the multiple colored portions.

In another embodiment, a vehicle interior assembly includes a printed fabric having multiple colored portions. The vehicle interior assembly also includes a substrate coupled to a non-show surface of the printed fabric. The substrate is configured to enhance rigidity of the fabric. Moreover, the substrate includes a recess, and a transition between two or more colored portions of the multiple colored portions is disposed within the recess.

### DRAWINGS

FIG. 1 is a perspective view of an embodiment of a vehicle that may include a fabric covered vehicle interior assembly having a recess.

FIG. 2 is a perspective view of an embodiment of an interior of the vehicle of FIG. 1 that may include a fabric covered vehicle interior assembly having a recess.

FIG. 3 is a process flow diagram of an embodiment of a process for manufacturing a fabric of the vehicle interior assembly of FIG. 2 including analyzing the vehicle interior assembly design and printing the analyzed design.

FIG. 4 is a process view of an embodiment of a method for forming the fabric covered vehicle interior assembly of FIG. 2.

FIG. 5 is a cross-sectional view of a recess in the fabric covered vehicle interior assembly of FIG. 2.

FIG. 6 is a cross-sectional view a sealed recess in the fabric covered vehicle interior assembly of FIG. 2.

### DETAILED DESCRIPTION

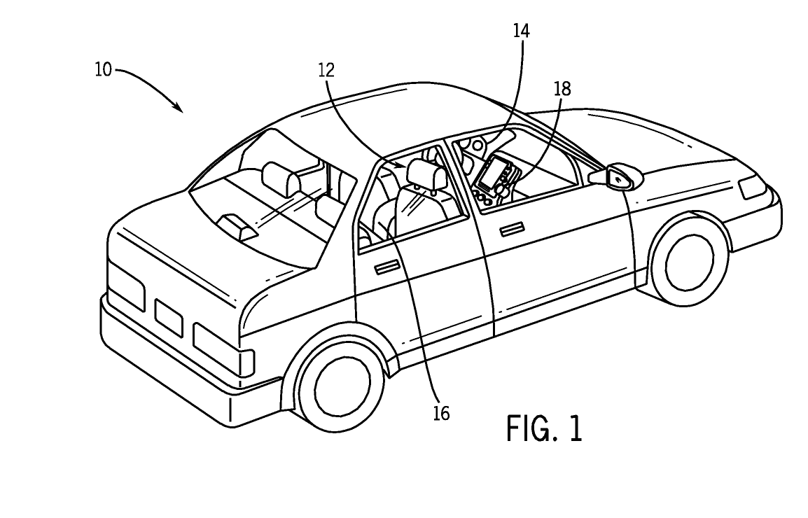

FIG. 1 is a perspective view of a vehicle 10 that may include a vehicle interior assembly having a recess. As illustrated, the vehicle 10 includes an interior 12 having an instrument panel 14, an armrest 16, and a center console 18. As discussed in detail below, the vehicle interior 12 includes a vehicle interior assembly having a recess. The vehicle interior assembly may be any suitable interior portion of the vehicle 10, such as a headliner. Moreover, the vehicle interior assembly includes a fabric having one or more colors disposed on the fabric to form one or more colored portions. The vehicle interior assembly also includes a substrate that enhances rigidity of the fabric. As discussed in detail below, the vehicle interior assembly may include a recess that at least partially conceals a transition between colors disposed on the fabric. By at least partially concealing the transition, the vehicle interior assembly may appear to include more panels than are actually included. For example, a single panel interior vehicle assembly may include 1, 2, 3, or more colored portions with partially concealed transitions. As a result, the interior vehicle assembly may appear to contain a separate panel for each of the colored portions. Furthermore, in certain interior assemblies, a transition may have imperfections (e.g., non-linear edges) when the vehicle interior assembly is mounted in a vehicle. Accordingly, in such embodiments, at least partially concealing the transition along a recess may improve the aesthetic quality of the vehicle interior assembly.

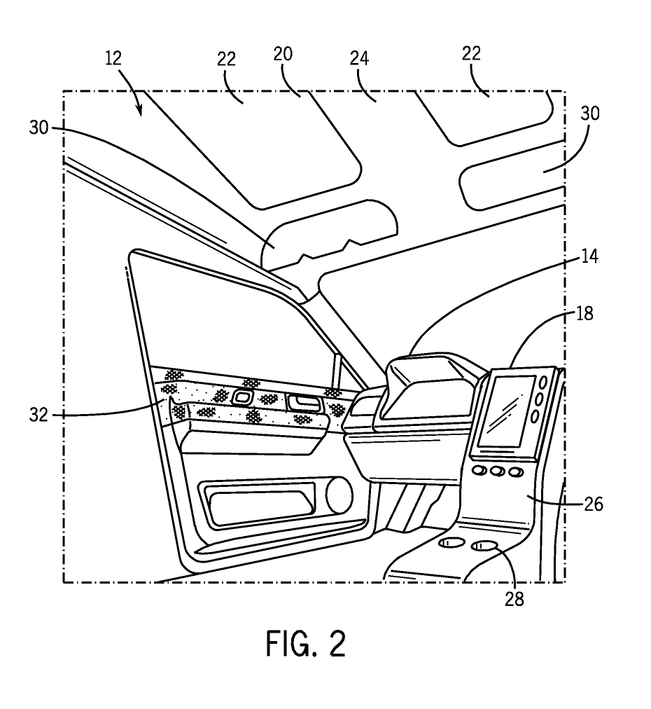

FIG. 2 is a perspective view of an embodiment of the interior 12 of the vehicle 10 of FIG. 1. As illustrated, the vehicle interior 12 includes a vehicle interior assembly 20 (e.g., headliner) having a first colored portion 22 and a second colored portion 24. In some embodiments, the first colored portion 22 and/or the second colored portion 24 may include designs or patterns that are disposed onto the vehicle interior assembly 20. These colored portions, designs, and/or patterns may be printed or dyed onto a fabric of the vehicle interior assembly 20. For example, in some embodiments, the fabric may be printed using a dye sublimation paper transfer. Additionally, some embodiments of the vehicle interior assembly 20 may include 1, 2, 3, 4, or more colored portions formed into any suitable design and/or pattern. In some embodiments, the vehicle interior 12 may include storage compartments 26 [not shown], cup holders 28, visors 30, interior door panels 32, and/or other suitable vehicle interior components that may include fabrics having multiple colors disposed thereon.

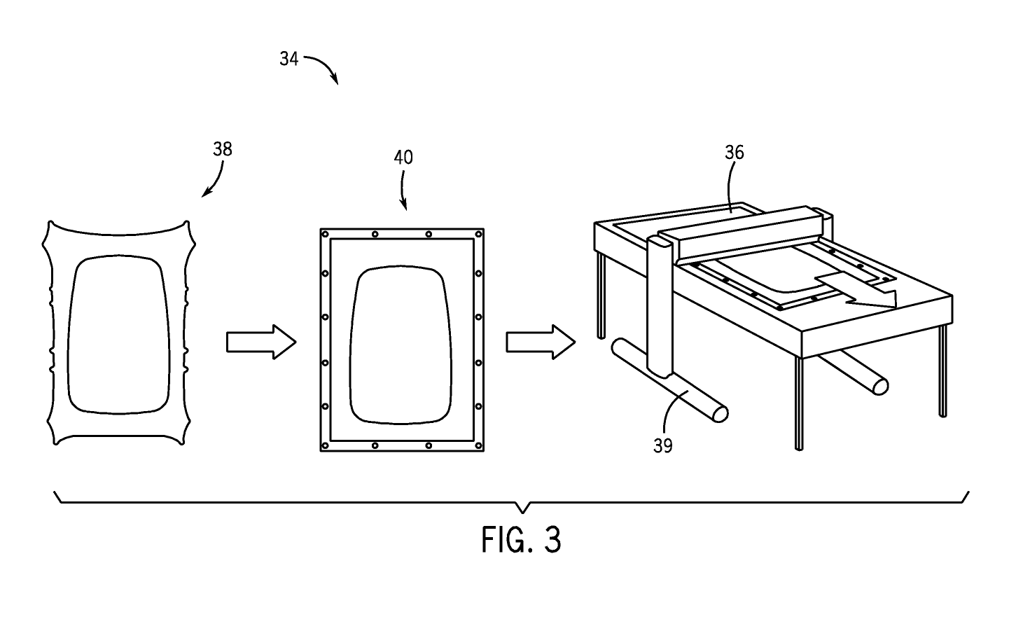

FIG. 3 is a process flow diagram of an embodiment of a process 34 for manufacturing a fabric 36 of the vehicle interior assembly 20. In certain embodiments, the fabric 36 may include tricot knit fabrics, other knit fabrics, synthetic polymers (e.g., nylon), woven fabrics, non-woven fabrics, leathers, artificial leathers, coated fabrics, acoustic fibers, other suitable fabrics, or a combination thereof In some embodiments, a vehicle interior assembly design 38 for the vehicle interior assembly 20 may be analyzed to determine any distortions that may occur from formation of a recess in the vehicle interior assembly 20, as discussed below. Additionally or alternatively, the analysis may include determining distortions that may occur from disposing on the fabric 36 on to a contoured substrate. Such distortions may be reduced using a design disposal tool 39 to dispose the vehicle interior assembly design 34 on the fabric 36 of the vehicle interior assembly 20. In some embodiments, the design disposal tool 39 may include a fabric printer (e.g., direct-to-fabric digital fabric printer), a loom that weaves colored fabric into a desired design, another suitable disposal tool, dye sublimation paper transfer equipment, or a combination thereof Some design disposal tools may establish various imperfections that may be predicted by analysis, and compensated for by using a recess. Moreover, in some embodiments, the analysis performed on the design may be performed using finite element analysis (FEA). Furthermore, some embodiments of the disclosure may analyze the vehicle interior assembly design 38 while considering stretching distortions of the fabric 36 that may occur when the fabric 36 is disposed in the vehicle interior 12. Once the vehicle interior assembly design 38 is analyzed, a pattern 40 that results from the analysis of the design 38 may be disposed on the fabric 36 to produce the vehicle interior assembly design 38 when a non-distorted vehicle interior assembly 20 is disposed within the vehicle 10.

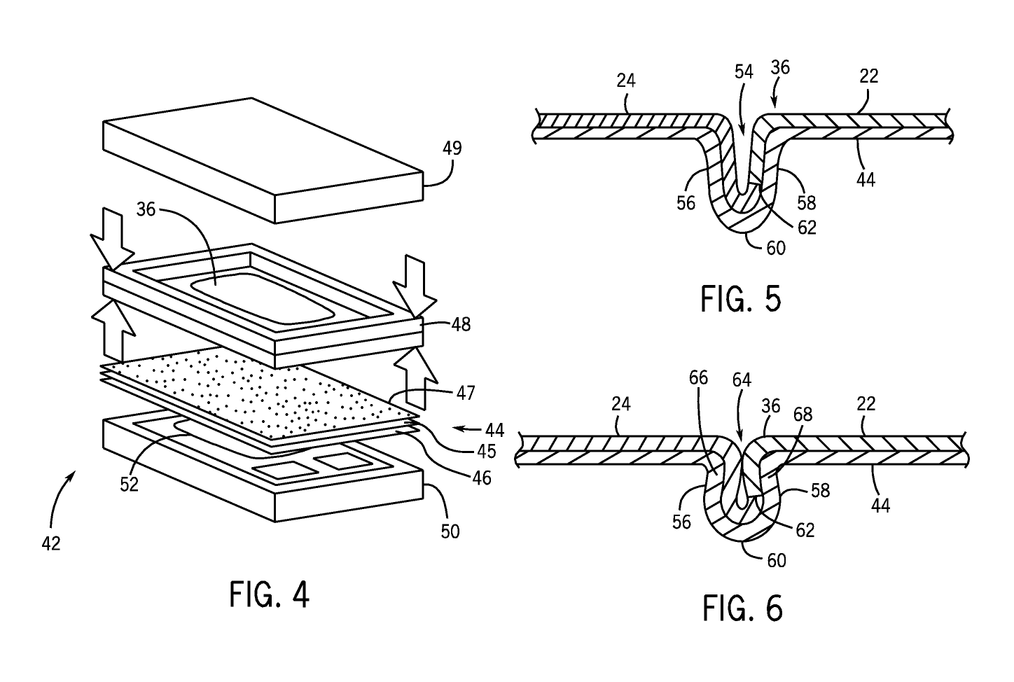

FIG. 4 is a process view of an embodiment of a method for forming the vehicle interior assembly 20. In certain embodiments, the vehicle interior assembly 20 is formed using a compression mold 42 that compresses the fabric 36 with a substrate 44. Additionally or alternatively, portions of the vehicle interior assembly 20 may be formed using other suitable formation processes (e.g., transfer molding, etc.). In some embodiments using the compression mold 42, the fabric 36 is held in place using a frame 46 that is then positioned within an upper mold 48 or a lower mold 50 of the compression mold 42 during the formation process. As may be appreciated, the frame 46 properly positions the fabric 36 during formation. In certain embodiments, the substrate 44 may be formed of a single material (e.g., honeycomb polymer) and/or containing a single layer (e.g., substrate layer formed from a polypropylene and fiberglass mixture). In some embodiments, the substrate 44 may be formed from a composite of other materials. For example, some embodiments of the substrate 44 may include a resilient layer 45 and an upper layer 46. In other embodiments, the substrate 44 may include a resilient layer 45 that is “sandwiched” between an upper layer 46 and a lower layer 47. In various embodiments, the resilient layer 45 may include polyurethane foam, another suitable foam, polypropylene (e.g., expanded polypropylene), a honeycomb material (e.g., honeycombed polymer) or a combination thereof. Furthermore, certain embodiments of the upper and/or lower layers 46, 47 may include fiberglass, other suitable materials, or a combination thereof.

In embodiments with a single-layer substrate, the resilient layer 45 may be coupled to the fabric 36 using material bonding (e.g., polyurethane foam is melted and adhered to the fabric 36), adhesives, welding, other suitable coupling methods, or a combination thereof. In embodiments having a sandwiched substrate, the lower layer 47 may be coupled to the fabric 36 using material bonding, adhesives, welding, other suitable coupling methods, or a combination thereof In various embodiments using a sandwiched substrate, the resilient layer 45 is coupled to the upper layer 46 and/or the lower layer 47 using adhesive, welding, or other suitable couplings. Furthermore, some embodiments of the vehicle interior assembly 20 may be formed without a resilient layer 45, upper layer 46, and/or lower layer 47. For example, some embodiments may include coupling the fabric 36 to an upper layer 46 without including a resilient layer 45 and/or a lower layer 47. Furthermore, some embodiments may include only a fabric layer 45 that is mounted in a vehicle interior 12.

During the formation process, a recess may be formed in the vehicle interior assembly 20. For example, the compression mold 42 may include a ridge in one mold (e.g., the upper mold 48) and a mold recess 52 in another mold (e.g., lower mold 50) such that the formation of the vehicle interior assembly 20 forms a recess in the substrate 44 and fabric 36.

FIG. 5 is a cross-sectional view of a recess 54 created during the formation of the vehicle interior assembly 20. The recess 54 includes a left wall 56, a right wall 58, and a recess peak 60. Furthermore, a color transition 62 on the fabric 36 may is disposed within the recess 54. The transition 62 represents a change from the first colored portion 22 to the second colored portion 24. In other words, the right wall 58 may be at least partially covered by a portion of the fabric 36 having the first colored portion 22, and the left wall 56 may be at least partially covered by a portion of the fabric 36 having the second colored portion 24. Because the color transition 62 occurs in the recess 54, the color transition 62 may be at least partially concealed from the vehicle interior 12. Additionally or alternatively, the recess 54 may conceal imperfections (e.g., undesired curvatures) of the color transition 62 in the vehicle interior assembly 20, thereby causing the color transition 62 to appear substantially straight to the vehicle interior 12.

FIG. 6 is a cross-sectional view of the recess 54 that has been sealed to form a sealed recess 64. The sealed recess 64 includes the left wall 56, the right wall 58, and the recess peak 60 similar to the recess 54 of FIG. 6. However, in some embodiments, the sealed recess 64 may include an upper left wall 66 that has been urged toward an upper right wall 68 to at least partially seal the sealed recess 64 by urging the first colored portion 22 against toward the second colored portion 24. In certain embodiments, the first colored portion 22 may be urged toward the second colored portion 24 using staples, clips, welding, pinching during the forming process, other suitable urging methods, or some combination thereof. In some embodiments, the upper left wall 66 and the upper right wall 68 may be urged such that the first colored portion 22 and the second colored portion 24 contact one another, but other embodiments of the sealed recess may include a gap between the first colored portion 22 and the second colored portion 24 after the upper left wall 66 and the upper right wall 68 have been urged together. Additionally, in some embodiments, other portions of the left wall 56 and the right wall 58 may be urged together. For example, in some embodiments, a lower portion of the left wall and the right wall may be urged together, or the entire left wall 56 and right wall 58 may be urged together. Furthermore, the recess 54 may be formed into the sealed recess 64 during the original formation of the recess 54 or in a subsequent process. In other words, the recess 54 may be sealed when formed, or subsequently sealed by urging the left wall 56 and the right wall 58 together after the recess 54 has been formed.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colored portions, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A vehicle interior assembly, comprising:
a fabric having a plurality of colored portions; and
a substrate coupled to the fabric and configured to enhance rigidity of the fabric, wherein the substrate comprises a recess, and having a transition of the fabric between a first colored portion of the plurality of colored portions and a second colored portion of the plurality of colored portions is disposed within the recess.

2. The vehicle interior assembly of claim 1, wherein the fabric comprises a printed pattern having the plurality of colored portions.

3. The vehicle interior assembly of claim 1, wherein the substrate comprises:
an upper layer; and
a resilient layer coupled to the upper layer between the fabric and the upper layer.

4. The vehicle interior assembly of claim 3, wherein the upper layer comprises a fiberglass material.

5. The vehicle interior assembly of claim 3, wherein the substrate comprises a lower layer coupled to the resilient layer between the fabric and the resilient layer.

6. The vehicle interior assembly of claim 5, wherein the upper layer and the lower layer each comprise a fiberglass material.

7. The vehicle interior assembly of claim 3, wherein the resilient layer comprises polyurethane, polypropylene, a honeycombed polymer, or a combination thereof.

8. The vehicle interior assembly of claim 1, wherein the substrate comprises a single layer comprising a mixture of polypropylene and fiberglass.

9. The vehicle interior assembly of claim 1, wherein the recess comprises:
a left wall that receives the first colored portion of the fabric; and
a right wall that receives the second colored portion of the fabric, wherein the left wall and the right wall are spaced to urge the first colored portion of the fabric into contact with the second colored portion of the fabric to at least partially conceal a peak of transition.

10. The vehicle interior assembly of claim 9, wherein the first colored portion of the fabric is urged into contact with the second colored portion using staples, clips, welding, pinching during formation, or some combination thereof.

11. A method of manufacturing a vehicle interior assembly, comprising:
coupling a fabric having a plurality of colored portions to a substrate; and
forming a recess in the fabric and the substrate, wherein the recess is configured to at least partially conceal a transition between two or more colored portions of the plurality of colored portions.

12. The vehicle interior assembly of claim 11, wherein the fabric comprises a printed pattern having the plurality of colored portions.

13. The method of claim 11, wherein forming the recess comprises:
aligning the fabric to a frame; and
aligning the frame to a molding device configured to mold the recess into the substrate and the fabric.

14. The method of claim 11, comprising substantially closing the recess by urging two adjacent walls of the recess toward one another

15. The method of claim 11, wherein forming the recess comprises using compression molding.

16. The method of claim 11, wherein forming the recess comprises using transfer molding.

17. The method of claim 11, comprising analyzing a vehicle interior assembly design to produce a pattern configured to establish a non-distorted pattern when the vehicle interior assembly is mounted in a vehicle.

18. A vehicle interior assembly, comprising:
a printed fabric having a plurality of colored portions; and
a substrate coupled to a non-show surface of the printed fabric, wherein the substrate is configured to provide rigidity of the fabric, the substrate comprises a recess, and a transition between two or more colored portions of the plurality of colored portions is disposed within the recess.

19. The vehicle interior assembly of claim 18, wherein the recess is configured to at least partially conceal the transition.

20. The vehicle interior assembly of claim 18, wherein walls of the recess are configured to urge the two or more colored portions together to at least partially conceal a peak of the transition.
